(19) United States
(12) Patent Application Publication
(10) Pub. No.: US 2010/0290977 A1
(43) Pub. Date: Nov. 18, 2010

(54) METHOD OF REMOVING HYDROCARBON IMPURITIES FROM A GAS

(76) Inventors: Charles W. BOWERS, Livermore, CA (US); William R. Gerristead, JR., High Bridge, NJ (US); Ravi Jain, Bridgewater, NJ (US); Yudong Chen, Boothwyn, PA (US)

Correspondence Address: The BOC Group, Inc., 575 MOUNTAIN AVENUE, MURRAY HILL, NJ, 07974-2082, US

(21) Appl. No.: 12/466,667

(22) Filed: May 15, 2009

(51) Int. Cl. C01B 31/20

(52) U.S. Cl. 423/437.1

(57) ABSTRACT

There is provided a method for purifying a gas stream such as for example a carbon dioxide gas stream by removing hydrocarbons from the carbon dioxide by heat exchange, impurity adsorption and cooling.

The present inventive embodiments provide a method and apparatus for removing impurities from a gas. In particular, this invention provides a method for removing hydrocarbons and carbon species from for example carbon dioxide.

Carbon dioxide is used in a number of industrial and domestic applications, many of which require the carbon dioxide to be free from various impurities. Unfortunately, carbon dioxide obtained from natural sources such as gas wells, chemical processes, fermentation processes or produced in industry, particularly carbon dioxide produced by the combustion of hydrocarbon products, often contains impurity levels of hydrocabons, sulfur compounds such as carbonyl sulfide (OCS, commonly written as COS) and hydrogen sulfide (H₂S). When the carbon dioxide is intended for use in an application that requires the carbon dioxide to be of high purity, such as in the manufacture and cleaning of foodstuffs and beverage carbonation, medical products, and electronic and optical devices, the impurities contained in the gas stream must be removed to very low levels if not eliminated prior to use. The level of impurity removal required varies according to the application of carbon dioxide. For example, during electronic cleaning applications, the total carbon species level in the carbon dioxide (CO₂), specifically those carbon species which result in formation of persistent solid and liquid non-volative residues, should be below 0.1 parts per million (ppm).

Since many end users of carbon dioxide require the carbon dioxide they use to be substantially free of hydrocarbons, and because natural sources of carbon dioxide and industrially manufactured carbon dioxide often contain such impurities, economic and efficient methods for effecting substantially complete removal of hydrocarbons from carbon dioxide gas streams, without concomitantly introducing other impurities into the carbon dioxide, are continuously sought

The present embodiments include a method of purifying a gas comprising heating a gas stream to above ambient temperature; passing the heated gas stream into an organic removal unit; cooling the heated gas stream exiting the organic removal unit to form a purified gas stream; and removing moisture and other impurities from the purified gas stream.

In an embodiment, the gas comprises carbon dioxide, and the impurities comprise carbon species.

For more complete understanding of the present embodiments, reference may be had to the description of the embodiments which follow taken in connection with the accompanying drawings, of which:

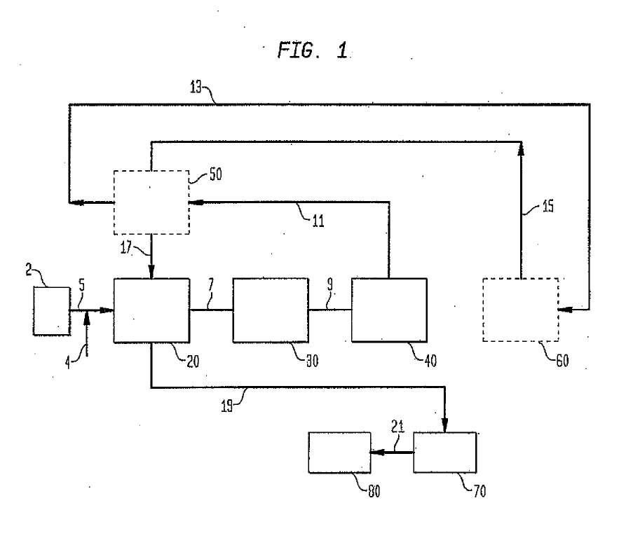

FIG. 1 is a schematic description of the overall process for removing hydrocarbon impurities from a gas stream, such as carbon dioxide;

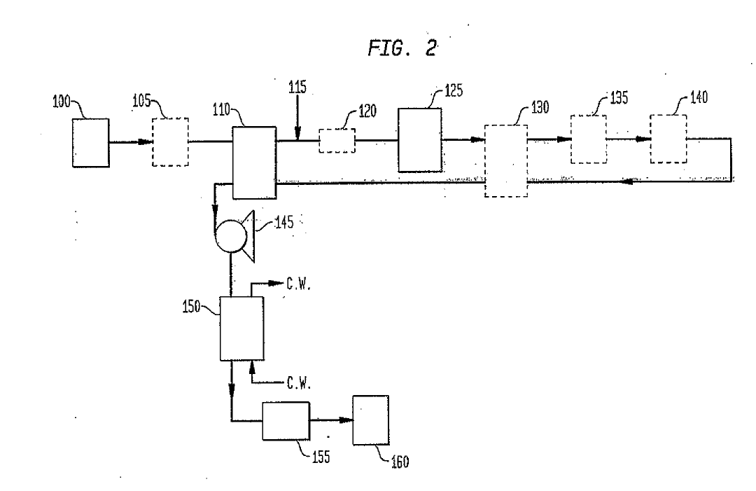

FIG. 2 is a schematic description of purifying carbon dioxide in a carbon dioxide production plant; and

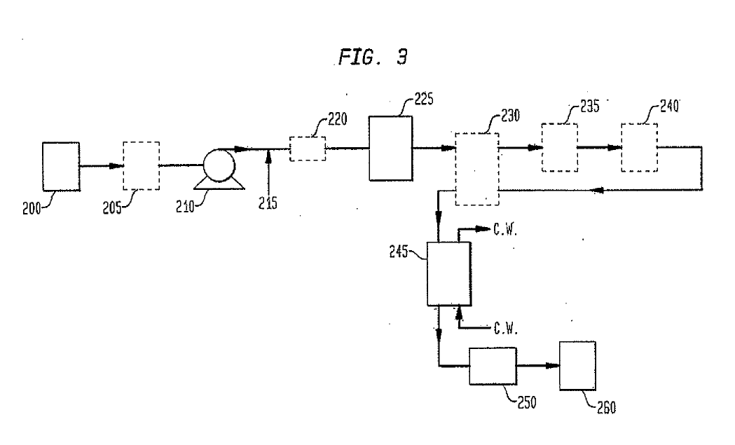

FIG. 3 is another schematic description of purifying carbon dioxide in a carbon dioxide production plant.

The carbon dioxide that is typically produced for industrial operations has impurities present in it. These impurities will often be a concern for many uses of the carbon dioxide. In the production of products intended for human consumption, such as carbonated beverages, and in the production of electronic components and equipment, the purity of the carbon dioxide is paramount and can influence the taste, quality, operation and legal compliance of the finished product. With respect to carbon impurities or species to be removed from the carbon dioxide, such impurities may be selected from at least one of aromatic hydrocarbons, aliphatic hydrocarbons and branched hydrocarbons.

The impure carbon dioxide which can be obtained from any available source of carbon dioxide will typically contain as impurities hydrocarbons and carbon species such as toluene, xylene, benzene, and aliphatic species, e.g. esters such as hexane. The embodiments provide for low cost methods for the removal of these impurities. The impurity removal can be used in various ways depending on whether the carbon dioxide is purified at a production plant, or at a point of use. Various point-of-use applications of carbon dioxide include a beverage filling plant, a food freezing plant, an electronics manufacturing plant and a fountain type carbon dioxide dispensing location.

For purposes of the embodiments, at least some of the impurities, such as toluene and xylene, are removed at an elevated temperature, a temperature of 50° to 150° C. In the point-of-use application, this temperature can be obtained by using a combination of heater and heat exchange means. In a production plant, this temperature may be obtained during the compression of feed carbon dioxide after the final compression stage but before the aftercooler. In a production plant, for the feed containing high levels of reactive sulfur species (>10 to several hundred ppms), removal of hydrocarbons should occur prior to compression, and the temperature for removal is obtained by heater and heat exchanger means. The impure carbon dioxide gas stream having been raised to the proper temperature is directed to an organic removal bed. This bed is typically a vessel that will contain certain catalyst and adsorbent materials which will either react with or adsorb the hydrocarbons.

Preferably the catalyst materials are those that will cause the hydrocarbons to convert to CO2 and moisture. Purification materials according to the inventive embodiments include noble-metal catalysts; metal oxides such as copper, zinc, chromium or iron oxide either alone or supported on a microporous adsorbent such as activated alumina, activated carbon or silica gel; monoliths; and metals of alumina substrates.

The stream exiting the hydrocarbon removal bed can optionally be further heated and sent to a catalytic reactor for oxidation of various hydrocarbon impurities. The stream exiting the reactor bed is cooled to close to ambient temperatures in heat exchange means.

Referring to FIG. 1, there is provided an overview of the carbon dioxide purification process according to the embodiments. Depending on impurities, such as hydrocarbon impurities, in the feed, some components of this process can be eliminated. Carbon dioxide containing impurities is directed from source 2 and line 5 to a first heat exchanger 20. Oxygen is added to this stream via line 4 for use in the sulfur removal bed and in the catalytic reactor (hydrocarbon removal unit). The first heat exchanger 20 will raise the temperature of the impure carbon dioxide from about ambient to between 40 and 120° C. The heated impure carbon dioxide leaves the first heat exchanger through line 7 to a heater 30 where its temperature is further increased to between 50 and 150° C. For certain situations the heat exchanger 20 may be eliminated and only heater 30 may be used to increase the temperature of the stream. The impure carbon dioxide leaves the heater through line 9 and enters the sulfur removal bed 40. The bed 40 contains various materials such as supported carbonates, hydroxides and oxides for the removal of various sulfur impurities such as hydrogen sulfide, COS and mercaptans.

The impure carbon dioxide which is now essentially free of most sulfur impurities is optionally directed through line 11 to a second heat exchanger 50 where its temperature is raised to over 150° C. The impure carbon dioxide exits the second heat exchanger through line 13 and is further heated to a temperature between 150 and 450° C. in a heater not shown. The heated carbon dioxide enters a catalyst reactor 60 containing a pelleted or a monolith catalyst. Various impurities including aromatic and aliphatic hydrocarbons such as toluene, benzene and aldehydes in the feed react with oxygen in the catalytic reactor and are converted to carbon dioxide and water, i.e. such that the hydrocarbons are destroyed or are removed from the carbon dioxide.

The now essentially purified carbon dioxide gas stream leaves the catalytic reactor bed through line 15 where it returns to the second heat exchanger 50.

The purified carbon dioxide gas stream leaves the second heat exchanger through line 17 and is directed into the first heat exchanger 20 where its temperature is reduced to less than 40° C. The cooled purified carbon dioxide gas steam can be sent to downstream processing equipment 70 through line 19 where it is further purified and optionally liquefied. It can also be sent to a CO₂ use process, unit 80, via line 21.

Purification of carbon dioxide in a carbon dioxide production plant is shown in FIGS. 2 and 3.

In FIG. 2, carbon dioxide from a source 100 is sent to an optional purification unit 105. This unit may consist of one or more purification processes chosen from adsorption, water wash column, electrostatic precipitator or a filtration unit. The carbon dioxide exiting unit 105 is sent to a heat exchanger 110 to raise its temperature to between 40 and 120° C. and oxygen is added to this stream at line 115. The stream exiting unit 110 is sent to an optional heater unit 120 to further increase its temperature to around between 50 and 150° C. and is then sent to the sulfur removal unit 125 where sulfur impurities such as hydrogen sulfide, carbonyl sulfide, and mercaptans are removed by reaction with metal oxides, hydroxides or carbonates, or copper exchanged zeolites. Some of the reaction products such as sulfur may also be adsorbed on supports such as activated carbons and activated alumina.

The stream exiting the sulfur removal unit 125 is further heated in an optional heat exchanger 130 and optional heater 135 and enters the optional catalytic reactor 140. The catalytic reactor contains supported noble metal catalysts such as palladium or platinum in pelleted or monolith forms. The catalytic reactor operates at a temperature between 150 and 450° C. depending on the impurities in the feed stream. The hydrocarbon impurities are oxidized to water and carbon dioxide in this reactor. The stream exiting reactor 140 is cooled in heat exchanger 130 and heat exchanger 110. If reactor 140 is not used, the stream exiting the sulfur bed 125 is cooled in heat exchanger 110. The stream exiting heat exchanger 110 is compressed in a compressor 145 to pressures between 10 and 20 bara and is cooled in an aftercooler 150 to a temperature close to ambient. The cooled, purified carbon dioxide gas steam can optionally be sent to downstream processing equipment 155 where it is further purified and optionally liquefied. It can also be sent to a CO₂ use process unit 160. “CW” identifies cold water introduced into and exiting from the aftercooler 150.

The embodiment in FIG. 2 is particularly advantageous for feeds containing high levels of sulfurs, from 10 ppm to several hundred ppms, and hydrocarbons. If this feed was sent directly to compressor 145, expensive materials of construction such as stainless steel may be needed to minimize the corrosion in the compressor. However, efficient high temperature removal of sulfurs in unit 125 obviates this need and a compressor made of carbon steel can be used, reducing the capital cost for the compressor by a factor 2 to 3.

In FIG. 3, carbon dioxide from source 200 is sent to an optional purification unit 205. This unit may consist of one or more purification processes chosen from adsorption, water wash column, electrostatic precipitator or a filtration unit. The carbon dioxide exiting unit 205 is sent to a compressor 210 to raise its pressure to between 10 and 20 bara and oxygen is added to the compressed stream at line 215. The stream exiting the final compression stage will be at a temperature between 70° and 95° C. and is sent to an optional heater unit 220 to further increase its temperature to between 80 and 150° C. and is then sent to the sulfur removal unit 225 where sulfur impurities such as hydrogen sulfide, carbonyl sulfide, and mercaptans are removed by reaction with metal oxides, hydroxides or carbonates, or copper exchanged zeolites. Some of the reaction products such as sulfur may also be adsorbed on supports such as activated carbons and activated alumina.

The stream exiting the optional sulfur removal unit 225 is further heated in an optional heat exchanger 230 and optional heater 235 and enters the optional catalytic reactor 240. The catalytic reactor contains supported noble metal catalysts such as palladium or platinum in pelleted or monolith forms. The catalytic reactor operates at a temperature between 150 and 4500C depending on the impurities in the feed stream. The hydrocarbon impurities are oxidized to water and carbon dioxide in this reactor. The stream exiting reactor 240 is cooled in heat exchanger 230 and is further cooled in an aftercooler 245 to a temperature close to ambient. The cooled, purified carbon dioxide gas steam can optionally be sent to downstream processing equipment 250 where it is further purified and optionally liquefied. It can also be sent to a CO₂ use process, unit 260. “CW” identifies cold water introduced into and existing from the aftercooler 245.

### EXAMPLE 1

A feed containing 9 ppm COS in carbon dioxide at a pressure of 14.6 bara and a temperature of 100° C. was passed through a bed containing 0.12 kgs of activated carbon containing 20 wt % potassium carbonate at a flow rate of 19.8 std liters/min. About 100 ppm of oxygen was added to the feed. An equilibrium COS capacity of 5.15 wt % was obtained at this temperature. The same feed was passed through the same bed at a temperature of 25° C. and an equilibrium COS capacity of <0.1 wt % was obtained.

### EXAMPLE 2

The same feed now containing 50 ppm H₂S in carbon dioxide at a pressure of 14.6 bara and a temperature of 100° C. was passed through a bed containing 0.154 kgs of activated carbon containing 20 wt % potassium carbonate at a flow rate of 15.6 std liters per min. About 100 ppm oxygen was added to the feed. An equilibrium H₂S capacity of 18 wt % was obtained. The same feed was passed through the same bed at a temperature of 25° C. and an equilibrium H₂S capacity of around 10 wt % was obtained.

Both these experiments indicate that a significant improvement in the removal capacity for COS and H₂S is possible by operating at an elevated temperature.

### EXAMPLE 3

Testing was performed using a purification skid containing 17.1 kgs of activated carbon impregnated with 20 wt % potassium carbonate. Carbon dioxide at a pressure of 17 bara, at a temperature of 85° C., and at a flow rate 109.7 std m³/hr was passed through the bed. The feed contained 25-100 ppb of ethyl and methyl mercaptans. No mercaptans were seen at the bed outlet during a test period of about one week.

### EXAMPLE 4

Initial testing of the beverage grade CO₂ using gas chromatagraph mass spectrometer (GC/MS) revealed hydrocabons heavier than C6 (chain of 6 carbon atoms in molecule) at levels in excess of 10 ppm. These hydrocarbons were indentified as toluene and benzene compounds commonly identified as belonging to the decane family. After purification with the carbon impurity removal embodiments, there was complete reduction of these compounds such that a pure CO₂ spectra down to parts per trillion (ppt) resolution was observed with the GC/MS.

It will be understood that the embodiments described herein are merely exemplary, and that a person skilled in the art may make many variations and modifications without departing from the spirit and scope of the invention. All such variations and modifications are intended to be included within the scope of the invention as described and claimed herein. It should be understood that embodiments described above are not only in the alternative, but may also be combined.

What is claimed is:

1. A method of removing carbon impurities selected from at least one of aromatic hydrocarbons, aliphatic hydrocarbons, and branched hydrocarbons from a gas stream, comprising:
a) heating a gas stream to above ambient temperature;
b) passing the heated gas stream to an impurity removal unit, the impurity removal unit comprising an organics removal bed;
c) cooling the heated gas stream from the impurity removal unit to form a purified carbon dioxide stream; and
d) removing moisture and other impurities from the purified gas stream.

2. The method of claim 1, further comprising adding oxygen to the gas stream prior to heating the gas stream to ambient temperature.

3. The method of claim 1, further comprising providing additional heating of the heated gas stream from the impurity removal unit; and passing the additional heated gas stream to a reactor bed to remove impurities by oxidation.

4. The method of claim 3, further comprising cooling the additional heated gas stream from the reactor bed.

5. The method of claim 1, wherein the gas stream is heated to a temperature of about 50° C. to about 150° C.

6. The method of claim 1, wherein said organics removal bed comprises a catalyst that reacts with the carbon impurities.

7. The method of claim 6, wherein said catalyst is selected from at least one of noble metals, metal oxides, monoliths and metals of alumina substrates.

8. The method of claim 1, wherein the gas stream is a low pressure impure carbon dioxide gas stream.

9. The method of claim 1, wherein the gas stream is from a low pressure impure carbon dioxide source.

10. The method of claim 1, wherein the carbon impurities comprise at least one of toluene, xylene, benzene, hexane and esters.

11. A method of removing carbon impurities from an impure low pressure carbon dioxide gas stream in a carbon dioxide production plant, comprising.
a) heating a carbon dioxide gas stream to above ambient temperature;
b) passing the heated carbon dioxide gas stream to an organics removal unit;
c) cooling the heated carbon dioxide gas stream from the organics removal unit to form a purified carbon dioxide gas stream;
d) compressing the purified carbon dioxide gas stream; and
e) removing moisture and other impurities from the purified carbon dioxide gas stream.

12. The method of claim 11, further comprising adding oxygen to the carbon dioxide gas stream prior to heating the carbon dioxide gas stream to above ambient temperature.

13. The method of claim 11, further comprising providing additional heating of the heated carbon dioxide gas stream from the organics removal unit; and passing the additional heated carbon dioxide gas stream to a reactor bed to remove impurities by oxidation.

14. The method of claim 13, further comprising cooling the further heated carbon dioxide stream from the reactor bed.

15. The method of claim 11, further comprising purifying the compressed carbon dioxide gas stream.

16. The method of claim 11, further comprising passing the purified carbon dioxide gas stream to a reaction process.

17. The method of claim 11, wherein said carbon impurities are selected from at least one of aromatic hydrocarbons, aliphatic hydrocarbons and branched hydrocarbons.

18. The method of claim 11, wherein heating said carbon dioxide gas stream is to a temperature of about 50° C. to about 150° C.

19. The method of claim 11, wherein said organics removal unit comprises an organics reactor bed.

20. The method of claim 19, wherein said organics reactor bed comprises a catalyst that reacts with the carbon impurities.

21. The method of claim 20, wherein said catalyst is selected from at least one of noble metals, metal oxides, monoliths and metals of alumina substrates.

22. A method of removing organic impurities from an impure carbon dioxide gas stream in a carbon dioxide production plant, comprising:
a) compressing the impure carbon dioxide gas stream;
b) passing the compressed impure carbon dioxide gas stream to an organics removal unit;
c) cooling the heated carbon dioxide gas stream from the organics removal unit to form a purified carbon dioxide gas stream; and
d) compressing the purified carbon dioxide gas stream.

23. The method of claim 22, further comprising adding oxygen to the compressed impure carbon dioxide gas stream prior to passing the compressed impure carbon dioxide gas stream to the organics removal unit.

24. The method of claim 22, further comprising heating of the compressed impure carbon dioxide gas stream prior to passing the compressed impure carbon dioxide gas stream to the organics removal unit.

25. The method of claim 22, further comprising providing additional heating of the heated compressed carbon dioxide gas stream from the organics removal unit; and passing the further heated compressed carbon dioxide gas stream to a reactor bed to remove impurities by oxidation.

26. The method of claim 22, further comprising removing moisture and other impurities.

27. The method of claim 22, further comprising purifying the compressed carbon dioxide gas stream.

28. The method of claim 22, further comprising passing the purified carbon dioxide gas stream to a reaction process.

29. The method of claim 22, wherein said organic impurities are selected from at least one of aromatic hydrocarbons, aliphatic hydrocarbons and branched hydrocarbons.

30. The method of claim 22, wherein heating said carbon dioxide gas stream is to a temperature of about 50° C. to about 150° C.

31. The method of claim 22, wherein said organics removal unit comprises an organics reactor bed.

32. The method of claim 31, wherein said organics reactor bed comprises a catalyst that reacts with the organic impurities.

33. The method of claim 32, wherein said catalyst is selected from at least one of noble metals, metal oxides, monoliths and metals of alumina substrates.

34. A method of removing impurities from a gas stream comprising:
a) heating a gas stream to above ambient temperature;
b) passing the heated gas stream to an organics removal unit;
c) cooling the heated gas stream from the organics removal unit to form a purified carbon dioxide stream; and
d) removing moisture and other impurities from the purified carbon dioxide stream.

35. The method of claim 34, wherein the impurities comprise organic species selected from at least one of aromatic hydrocarbons, aliphatic hydrocarbons and branched hydrocarbons.

36. The method of claim 34, wherein the heating is to a temperature of about 50° C. to about 150° C.
